(19) United States
(12) Patent Application Publication
(10) Pub. No.: US 2016/0034010 A1
(43) Pub. Date: Feb. 4, 2016

(54) ELECTRONIC DEVICE HAVING A PROGRAMMED ELECTRICAL CHARACTERISTIC

(71) Applicant: Leeo, Inc., Palo Alto, CA (US)

(72) Inventors: Adam M. Gettings, Red Wing, MN (US); Andrew G. Stevens, Palo Alto, CA (US); Bjorn Hovland, Woodside, CA (US); Nina S. Joshi, Saratoga, CA (US); Yi Zheng, Palo Alto, CA (US); Lucas Ivers, Mountain View, CA (US)

(21) Appl. No.: 14/732,684

(22) Filed: Jun. 6, 2015

Related U.S. Application Data
(63) Continuation-in-part of application No. 14/448,849, filed on Jul. 31, 2014, now abandoned.
Application No. 14/448,849 is a continuation of application No. PCT/US2014/048727, filed on Jul. 29, 2014.

(51) Int. Cl. G06F 1/26; G06F 1/32

(52) U.S. Cl. CPC G06F 1/26; G06F 1/3287; G06F 1/3246

(57) ABSTRACT

An electronic device that generates a programmed electrical characteristic is described. During operation, the electronic device generates a programmed electrical characteristic associated with a predefined identifier that specifies information about the electronic device (such as a type, a model, a brand, an operating condition of the electronic device, and/or a unique identifier of the electronic device). For example, an integrated circuit in the electronic device may have a varying power consumption based on the predefined identifier. In particular, the programmed electrical characteristic may be associated with execution of a program module by a processor, such as initialization of firmware by the processor. The resulting modulated waveform may be detected and analyzed by another electronic device to determine the predefined identifier and, thus, a device profile (with the specified information) for the electronic device.

### CROSS REFERENCE TO RELATED APPLICATION

This application is a continuation-in-part of U.S. patent application Ser. No. 14/448,849, entitled “Electronic Device Having a Programmed Electrical Characteristic,” by Adam M. Gettings, Andrew G. Stevens, Bjorn Hovland, Nina S. Joshi, Yi Zheng, and Luke Ivers, Attorney docket number LEEO-N-Z008.00-US, filed on Jul. 31, 2014, which is a continuation of International Application No. PCT/US2014/048727 filed Jul. 29, 2014, the contents both of which are herein incorporated by reference.

### BACKGROUND

1. Field

The described embodiments relate generally to an electronic device having a programmed electrical characteristic, and more specifically to techniques for identifying an electronic device having a programmed electrical characteristic.

2. Related Art

Trends in connectivity and in portable electronic devices are resulting in dramatic changes in people's lives. For example, the Internet now allows individuals access to vast amounts of information, as well as the ability to identify and interact with individuals, organizations and companies around the world. This has resulted in a significant increase in online financial transactions (which are sometimes referred to as ‘ecommerce’). Similarly, the increasingly powerful computing and communication capabilities of portable electronic device (such as smartphones and tablets), as well as a large and growing set of applications, are accelerating these changes, providing individuals access to information at arbitrary locations and the ability to leverage this information to perform a wide variety of tasks.

Recently, it has been proposed these capabilities be included in other electronic devices that are located throughout our environments, including those that people interact with infrequently. In the so-called ‘Internet of things,’ it has been proposed that future versions of these so-called ‘background’ electronic devices be outfitted with more powerful computing capabilities and networking subsystems to facilitate wired or wireless communication. For example, the background electronic devices may include: a cellular network interface (LTE, etc.), a wireless local area network interface (e.g., a wireless network such as described in the Institute of Electrical and Electronics Engineers (IEEE) 802.11 standard or Bluetooth™ from the Bluetooth Special Interest Group of Kirkland, Wash.), and/or another type of wireless interface (such as a near-field-communication interface). These capabilities may allow the background electronic devices to be integrated into information networks, thereby further transforming people's lives.

However, the overwhelming majority of the existing background electronic devices in people's homes, offices and vehicles have neither enhanced computing capabilities (such as processor that can execute a wide variety of applications) nor networking subsystems. Given the economics of many market segments (such as the consumer market segment), these so-called ‘legacy’ background electronic devices (which are sometimes referred to as ‘legacy electronic devices’) are unlikely to be rapidly replaced.

These barriers to entry and change are obstacles to widely implementing the Internet of things. For example, in the absence of enhanced computing capabilities and/or networking subsystems it may be difficult to communicate with the legacy electronic devices. Furthermore, even when electronic devices include enhanced computing capabilities and/or networking subsystems, it may be difficult to communicate with electronic devices that use different communication protocols. These challenges may make it difficult to perform basic tasks such as identifying particular electronic devices, and thus may limit the applications and tasks that can be performed.

### SUMMARY

The described embodiments relate to an electronic device that includes a power supply that is electrically coupled to external electrical-connection nodes in the electronic device, and which provides a power signal. Moreover, an integrated circuit in the electronic device, which is coupled to the power supply, has, during operation, a programmed electrical characteristic associated with a predefined identifier that specifies information about the electronic device. This programmed electrical characteristic includes varying a power consumption of the electronic device that is expressed on the external electrical-connection nodes.

Note that the information includes: a type of the electronic device, a model of the electronic device, a brand of the electronic device, an operating condition of the electronic device, and/or a unique identifier of the electronic device.

Moreover, the programmed electrical characteristic may include a power-up transient signal of the electronic device. Furthermore, the programmed electrical characteristic may be time varying and may include: a current, a voltage, a phase relative to at least a reference signal, a quality factor, a harmonic of a fundamental frequency, a resonance frequency, a time constant, and/or noise. Additionally, the programmed electrical characteristic may include a time-varying power consumption of the electronic device, where the time variation includes a sequence of approximately discrete values (such as two or more power-consumption levels). However, in other embodiments the programmed electrical characteristic is generated using a spread-spectrum modulation technique.

Note that the programmed electrical characteristic may correspond to (or be related to or a function of): a pulse-code modulation sequence, a quadrature-modulation sequence, and/or a DC-balanced sequence. Alternatively or additionally, the programmed electrical characteristic may include information encoded with: an error-detection code, a parity-bit technique, a checksum, a hash function, a cyclic-redundancy check, a hamming code, and/or an error-correction code.

In some embodiments, the electronic device includes a storage component that stores additional information specifying the predefined identifier. For example, the storage component may include: a non-volatile memory, an array of resistors, a memory circuit, and/or a fusable link.

Moreover, the integrated circuit may include a processor. During operation of the electronic device, the programmed electrical characteristic may be associated with execution of a program module by the processor. For example, the programmed electrical characteristic may be associated with initialization of firmware by the processor.

Furthermore, the external electrical-connection nodes may be electrically couple to a second electronic device. Additionally, the electronic device may include an electrical-characteristic detector (which may be included in the power supply) that is electrically coupled to the external electrical-connection nodes, and which detects another programmed electrical characteristic associated with the second electronic device from a varying power consumption of the second electronic device. Note that the other programmed electrical characteristic may include a modulated waveform, and the electronic device may include a signal filter that removes noise from the modulated waveform prior to the electrical-characteristic detector.

In some embodiments, the electrical-characteristic detector analyzes the other programmed electrical characteristic, and associates the other programmed electrical characteristic with a device profile. An interface circuit in the electronic device may communicate information with a third electronic device. In particular, during operation another predefined identifier of the other electronic device and/or the device profile associated with the other programmed electrical characteristic may be communicated, via the interface circuit, to the third electronic device.

Furthermore, during operation of the electronic device, the processor may execute an interrupt service routine program that performs the analysis and the association when the processor receives an interrupt from the electrical-characteristic detector (such as when the modulated waveform is received).

Another embodiment provides a computer-program product for use in conjunction with the electronic device. This computer-program product may include instructions for at least some of the aforementioned operations performed by the electronic device.

Another embodiment provides a method for generating the programmed electrical characteristic in the electronic device. During operation, the electronic device obtains the predefined identifier that specifies the information about the electronic device. Then, a control mechanism in the electronic device generates the programmed electrical characteristic associated with the predefined identifier during operation of the electronic device, where the programmed electrical characteristic includes varying the power consumption of the electronic device.

Another embodiment provides a method for associating the other programmed electrical characteristic with a device profile. During operation, the electronic device receives the modulated waveform that corresponds to (or represents or is a function of) the other programmed electrical characteristic. Then, the electrical-characteristic detector in the electronic device analyzes the other programmed electrical characteristic, and associates the other programmed electrical characteristic with the device profile.

The preceding summary is provided as an overview of some exemplary embodiments and to provide a basic understanding of aspects of the subject matter described herein. Accordingly, the above-described features are merely examples and should not be construed as narrowing the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a block diagram illustrating electronic devices communicating in accordance with an embodiment of the present disclosure.

FIG. 2 is a block diagram illustrating an electronic device of FIG. 1 in accordance with an embodiment of the present disclosure.

FIG. 3 is a block diagram illustrating a data structure with one or more predefined identifiers in the electronic device of FIG. 2 in accordance with an embodiment of the present disclosure.

FIG. 4 is a flow diagram illustrating a method for generating a programmed electrical characteristic in an electronic device of FIG. 1 in accordance with an embodiment of the present disclosure.

FIG. 5 is a drawing illustrating a programmed electrical characteristic of an electronic device of FIG. 1 in accordance with an embodiment of the present disclosure.

FIG. 6 is a drawing illustrating communication within an electronic device during the method of FIG. 4 in accordance with an embodiment of the present disclosure.

FIG. 7 is a flow diagram illustrating a method for associating a programmed electrical characteristic with a device profile for an electronic device of FIG. 1 in accordance with an embodiment of the present disclosure.

FIG. 8 is a drawing illustrating communication within an electronic device during the method of FIG. 7 in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

An electronic device that generates a programmed electrical characteristic is described. During operation, the electronic device generates a programmed electrical characteristic associated with a predefined identifier that specifies information about the electronic device (such as a type, a model, a brand, an operating condition of the electronic device, and/or a unique identifier of the electronic device). For example, an integrated circuit in the electronic device may have a varying power consumption based on the predefined identifier. In particular, the programmed electrical characteristic may be associated with execution of a program module by a processor, such as initialization of firmware by the processor. The resulting modulated waveform may be detected and analyzed by another electronic device to determine the predefined identifier and, thus, a device profile (with the specified information) for the electronic device.

In this way, the electronic device may provide the predefined identifier (and/or the specified information) to the other electronic device, such as when the electronic device is powered on. This information may facilitate a variety of services for the electronic device (such as maintenance, ordering spare parts, etc.) and/or for a user of the electronic device. Consequently, these services may occur even when direct communication of the predefined identifier and/or the information among the electronic device and one or more other electronic devices is not desired (e.g., due to power-consumption constraints or interference) or is not possible (such as when a packet cannot be communicated among the electronic device and the one or more other electronic devices, e.g., when one or more of the electronic devices does not have the ability to communicate with the other electronic devices). The resulting improved functionality and services offered by the electronic device may promote sales of the electronic device (and, more generally, commercial activity) and may enhance customer satisfaction with the electronic device.

Note that this communication technique is not an abstract idea. In particular, the generation of the programmed electrical characteristic and the association of the device profile with the electronic device included in embodiments of the communication technique are not: a fundamental economic principle, a human activity (the operations in the communication technique typically involve frequencies exceeding the dynamic response of humans, and involve measurements in a noisy environment), and/or a mathematical relationship/formula. Moreover, the communication technique amounts to significantly more than an alleged abstract idea. In particular, the communication technique may improve the functioning of the electronic device that executes software and/or implements the communication technique. For example, the communication technique may: speed up computations performed during the communication technique; reduce memory consumption when performing the computations; improve reliability of the computations (as evidenced by improved identification of the electronic device); reduce network latency (e.g., by avoiding direct communication of the predefined identifier and/or the information among the electronic device and the one or more other electronic devices); improve the user-friendliness of a user interface that displays results of the computations (e.g., by allowing a user to view the information about the electronic device); and/or improve other performance metrics related to the function of the electronic device.

Communication between electronic devices (such as the electronic device and the one or more other electronic device) may utilize wired, optical and/or wireless communication. In the discussion that follows, wired communication is used as an illustrative example. This wired communication may involve or may be compatible with: a power-line communication standard, a universal serial bus (USB) communication standard, an inter-integrated circuit (or I2C) communication standard, and/or another wired communication standard or technique.

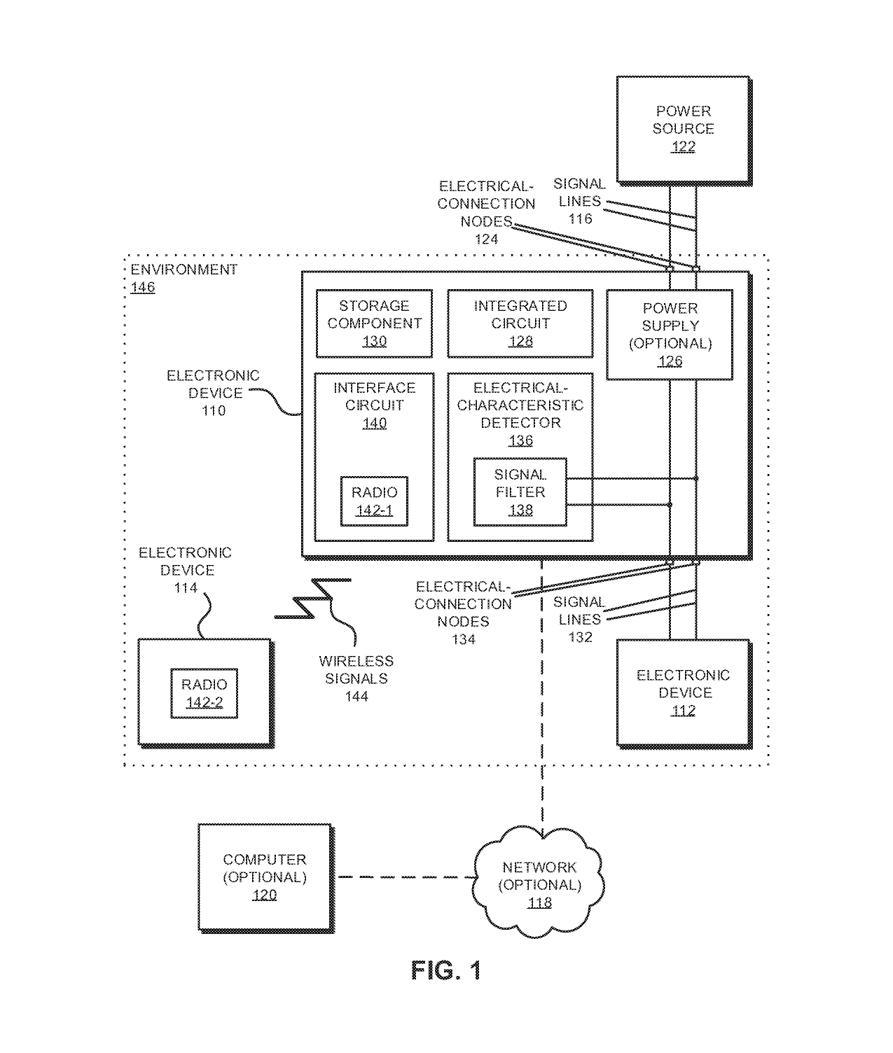

The communication between the electronic devices is shown in FIG. 1, which presents a block diagram illustrating communication among electronic device 110, electronic device 112 and electronic device 114 (either of which may be another instance of electronic device 110 or a legacy electronic device), and with optional computer 120 via optional network 118 (such as the Internet, a wireless local area network, an Ethernet network, an intra-net, an optical network, etc.), which may or may not involve wireless signals. In particular, the communication among electronic devices 110 and 112 may occur via signal lines 132, such as power-signal lines connecting these electronic devices. Moreover, signal lines 116 may electrically couple electronic device 110 to an external power source 122 (such as a generator, a battery, a power station, etc.). For example, electronic device 110 may be electrically coupled to signal lines 116 via electrical-connection nodes 124 (or external electrical-connection nodes), so that power source 122 can supply an input power signal to electronic device 110. Moreover, electronic device 110 may include an optional power supply 126 (such as a regulated power supply, a DC power supply, an AC power supply, a switched-mode power supply, etc.) that provides a power signal to components in electronic device 110 (such as one or more integrated circuits).

During operation, an integrated circuit 128 in electronic device 110 may generate or may have a programmed electrical characteristic based on a predefined identifier (such as a numerical or an alphanumerical code or value) that specifies information about electronic device 110. Thus, the electrical characteristic may be programmable or programmed (which in this disclosure are considered equivalent) so that it changes based on the predefined identifier. Note that the information may include: a type of electronic device 110, a model of electronic device 110, a brand of electronic device 110, an operating condition of electronic device 110, and/or a unique identifier of electronic device 110. For example, the programmed electrical characteristic may include varying a power consumption of integrated circuit 128 and, thus, of electronic device 110, such as a power-up transient signal of integrated circuit 128 and/or electronic device 110, which may repeat one or more times during power up. More generally, the programmed electrical characteristic may include a time-varying: current, voltage, phase relative to at least a reference signal, quality factor, harmonic of a fundamental frequency, resonance frequency, time constant, and/or noise.

In some embodiments, the power-up transient signal (and, more generally, the programmed electrical characteristic) only occurs or only is generated during power up of electronic device 110, such as during the transient variations in voltage that occur during power up. (In the discussion that follows, the power-up transient signal is used as an illustration of the programmed electrical characteristic.) However, in other embodiments the power-up transient signal occurs or is generated after power up (i.e., after electronic device is fully powered up or at a steady state) and/or may only occur or be generated after power up. Moreover, the power-up transient signal may occur or be generated in response to an identification request that is received from another electronic device. Furthermore, the power-up transient signal may occur or be generated the first time electronic device 110 is turned on or powers up at a particular location or the first time electronic device 110 communicates with another electronic device. In some embodiments, the power-up transient signal occurs or is generated repeatedly (such as periodically) until an acknowledgement or a response is received from at least another electronic device in environment 146. Thus, the power-up transient signal may occur or be generated: once, after a time interval (such as every 5, 10, 30 or 60 min), and/or as needed or dynamically based on changes in environment 146, such as when a new electronic device is present in environment 146. Note that the unique identifier of electronic device 110 may be remotely programmed by another electronic device, such that the unique identifier may be dynamically changed as needed. For example, the unique identifier may be used for a particular time interval (such as 1 hour, 1 day, 1 week, or 1 month, etc.) and then may be changed. When the unique identifier is changed, a processor may execute a program module so that the programmable electrical characteristic occurs or is generated (e.g., as described below, one or more logical blocks may be sequentially turned on or off to produce a time-varying power consumption). Alternatively or additionally, information specifying one of a set of program modules is received from another electronic device so that the programmable electrical characteristic is dynamically and remotely programmed (e.g., by change the number of logical blocks that are turned on or off when the program module is executed by a processor). When the information is received, the processor may execute the selected or specified program module so that the programmable electrical characteristic occurs or is generated.

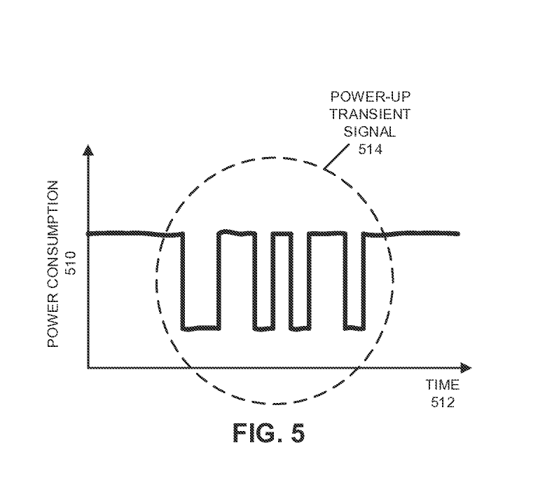

As described further below with reference to FIG. 5, the time-varying power consumption of integrated circuit 128 and/or electronic device 110 may include a sequence of approximately discrete values (such as two or more power-consumption levels). Moreover, the programmed electrical characteristic may correspond to (or be related to or a function of): a pulse-code modulation sequence, a quadrature-modulation sequence, and/or a DC-balanced sequence. In some embodiments, the programmed electrical characteristic is generated using a spread-spectrum modulation technique. Alternatively or additionally, the programmed electrical characteristic may include information encoded with: an error-detection code, a parity-bit technique, a checksum, a hash function, a cyclic-redundancy check, a hamming code, and/or an error-correction code. In some embodiments, the information included in the programmed electrical characteristic may be encrypted, e.g., using a symmetric encryption technique, an asymmetric encryption technique and/or a secure or one-way cryptographic hash function (such as SHA-256).

In some embodiments, electronic device 110 includes a storage component 130 that stores the predefined identifier and/or additional information (such as a program module) that specifies the predefined identifier. For example, storage component 130 may include: a non-volatile memory, an array of resistors, a memory circuit, and/or a fusable link.

In an exemplary embodiment, integrated circuit 128 includes a processor. During operation of electronic device 110, the programmed electrical characteristic may be associated with execution of the program module by the processor. For example, the programmed electrical characteristic may be associated with initialization of firmware by the processor. In some embodiments, the program module (or the firmware) is executed by the processor solely for the purpose of providing the programmed electrical characteristic. When executed, the program module may sequentially turn or power one or more logical blocks in the processor on or off (and/or may change the level of activity in the one or more logical blocks in the processor, i.e., to produce a grey-scale value) to temporally vary the power consumption by electronic device 110 to produce or generate the programmed electrical characteristic. This variation may change the current through electronic device 110 without changing the resistance or load resistance across electrical nodes 124 and/or 132. (In addition, the programmed electrical characteristic may be other than a load requirement of electronic device 110.) Note that the logic blocks may be turned on and off without electronic device 110 performing another function, such as communicating information with another electronic device. Thus, the varying current associated with execution of the program module may produce a corresponding time-varying voltage across electrical nodes 124 and/or 132, which can be used to convey the predefined identifier of electronic device 110 (a similar approach may be used to identify other electronic devices in environment 146).

However, in other embodiments integrated circuit 128 varies the power consumption by turning one or more circuits on or off using hardware. In general, the power consumption may be varied using hardware and/or software.

Furthermore, electronic device 110 may include electrical-connection nodes 134 (or additional external electrical-connection nodes) that electrically couple electronic device 110 to electronic device 112 (i.e., these electronic devices may be electrically coupled in series). Via electrical-connection nodes 134 and signal lines 132, optional power supply 126 may supply a power signal to electronic device 112. In some embodiments, electronic device 110 selectively electrically couples the power signal(s) to electronic device 112 (such as based on an environmental condition in an external environment 146 that includes electronic devices 110 and/or 112). For example, electronic device 110 may include a switch, such as an electrically operated switch or relay, or an electromechanical component that can interrupt a circuit and/or divert current from electrical-connection nodes 134. The switch may be single pole or multiple pole, and may (or may not) be make before break. Thus, the switch may selectively switch between a closed state and an open state. While a series configuration is illustrated in FIG. 1, in some embodiments electronic device 110 and/or electronic device 112 may be electrically coupled in parallel to signal lines 116 and/or 132 (i.e., a parallel configuration). Note that electrical-connection nodes 124 and/or 134 may include: a light socket, a rotatable connector configured to electrically couple to a light socket, an AC power plug, an AC power socket, a multi-wire electrical terminal, a DC power plug, a DC power socket, and/or a USB-compatible connector. Thus, electrical-connection nodes 124 and/or 134 may include: male connectors, female connectors and/or wires.

In either the series or the parallel configuration, the power signal(s) on signal lines 132 may include a modulated waveform that corresponds to (or is related to or a function of) the programmed electrical characteristic. This may allow electronic device 112 to determine the predefined identifier of electronic device 110. For purposes of illustration, in the discussion that follows, during operation an integrated circuit in electronic device 112 generates another programmed electrical characteristic corresponding to its predefined identifier. The resulting modulated waveform on signal lines 132 is detected by electronic device 110, which allows electronic device 110 to determine the predefined identifier of electronic device 110.

In particular, an electrical-characteristic detector 136 in electronic device 110 (which may be included in or separate from optional power supply 126) may detect the other programmed electrical characteristic associated with electronic device 112 from a varying power consumption of electronic device 112. This other programmed electrical characteristic may include a modulated waveform, and electronic device 110 may include a signal filter 138 (such as low-pass filter or a band-pass filter) that removes noise from the modulated waveform prior to additional analysis performed by electrical-characteristic detector 136. (As illustrated in FIG. 1, in some embodiments signal filter 138 is included in electrical-characteristic detector 136.) In an exemplary embodiment, electrical-characteristic detector 136 includes: a voltmeter, an ammeter, a power meter, a phase detector, a resonance monitor, a Fourier analyzer, a spectrum analyzer, a lock-in amplifier (which may be synchronized to the time varying power consumption of electronic device 112 via a synchronization signal from electronic device 112 and/or based on analysis of the power signal(s) between electronic devices 110 and 112), an averaging circuit (that averages multiple measurements of the modulated waveform), a heterodyne receiver (and, more generally, a demodulator), and/or another measurement device that measures or captures one or more instances of the modulated waveform. Thus, the measurements or the analysis performed by electrical-characteristic detector 136 may include synchronous or asynchronous detection. In an exemplary embodiment, electrical-characteristic detector 136 detects the other programmed electrical characteristic using circuit information about whether a series or parallel configuration is being used. For example, electrical-characteristic detector 136 may use a circuit model to correct or scale the measured modulated waveform for losses, different circuit branches or impedances of electronic devices 110 and/or 112. Note that this circuit information may be predefined and/or may be determined by electrical-characteristic detector 136.

Then, electrical-characteristic detector 136 (and/or electronic device 110) may analyze the other programmed electrical characteristic, and may associate the other programmed electrical characteristic with a (predefined) device profile of electronic device 112. For example, the other programmed electrical characteristic may be analyzed to determine the predefined identifier of electronic device 112. Next, this determined predefined identifier may be used to obtain the device profile. In particular, the device profile may be obtained locally (on electronic device 110) using the determined predefined identifier and a stored look-up table. Alternatively or additionally, an interface circuit 140 (or a network interface) in electronic device may access this information remotely, such as from optional computer 120 via optional network 118.

In an exemplary embodiment, during operation of electronic device 110, the processor may execute an interrupt service routine program that performs the analysis and the association when the processor receives an interrupt from electrical-characteristic detector 136 (such as when the modulated waveform is received by electrical-characteristic detector 136).

Furthermore, using interface circuit 140, electronic device 110 may communicate the determined predefined identifier and/or the device profile of electronic device 112 with one or more other electronic devices, such as electronic device 114. For example, electronic device 110 may wirelessly communicate packets with information specifying the determined predefined identifier and/or the device profile to electronic device 114. These packets may be included in frames in one or more wireless channels. Consequently, interface circuit 140 may include a radio 142-1 that transmits wireless signals 144 to electronic device 114, which are received by radio 142-2. In general, the wireless communication between electronic devices 110 and 114 may or may not involve a connection being established among these electronic devices, and therefore may or may not involve communication via a wireless network. Note that the communication between optional computer 120 and electronic device 110 via optional network 118 may involve a different communication protocol than that associated with wireless signals 144.

In this way, the communication technique may allow electronic devices 110 and 112 to indirectly communicate their predefined identifiers without or excluding direct communication of this information (such as via packets) between electronic devices 110 and 112. Instead, the predefined identifiers may be communicated in the power signal(s) on signal lines 132. This information (as well as the associated device profiles) may facilitate a variety of services and improved functionality of the electronic devices in FIG. 1. For example, services may be offered to: users associated with electronic devices 110 and/or 112 (such as owners or renters of these electronic devices), suppliers of components or spare parts, maintenance personnel, security personnel, emergency service personnel, insurance companies, insurance brokers, realtors, leasing agents, apartment renters, hotel guests, hotels, restaurants, businesses, organizations, governments, potential buyers of physical objects, a shipping or transportation company, etc. In particular, the predefined identifiers and/or device profiles may allow particular users (and their associated needs or preferences) to be determined, as well as particular electronic devices (and their associated components, maintenance requirements, failure mechanisms/estimated operating life, etc.) to be identified. Thus, the service(s) may include adapting or changing the function or operation of one or more electronic devices in FIG. 1 (such as a legacy electronic device and/or a regulator device, which may not directly communicate information with electronic devices 110 and/or 112) based on the needs or preferences of a user associated with electronic devices 110 and/or 112, who is, therefore, in proximity. In this way, an environmental condition (such as the temperature, humidity, an illumination pattern, etc.) in external environment 146 may be dynamically modified. In addition, once the information associated with electronic devices 110 and/or 112 is known, the service(s) may include maintenance notifications about electronic devices 110 and/or 112. For example, electronic device 110 may include one or more sensors that monitor the environmental condition in external environment 146 (such as an acoustic signal from a fire or carbon-monoxide detector that indicates a failing battery). Based on the environmental condition and the predefined identifier of electronic device 112, electronic device 110 may provide a maintenance notification to a user's cellular telephone (e.g., via optional network 118) to replace the battery or to perform another remedial action (such as a repair or service to be performed on electronic device 112).

Although we describe the environment shown in FIG. 1 as an example, in alternative embodiments, different numbers or types of electronic devices may be present. For example, some embodiments comprise more or fewer electronic devices. Furthermore, while not shown in FIG. 1, one or more components in electronic device 110 may be coupled or connected by additional signals lines or a bus.

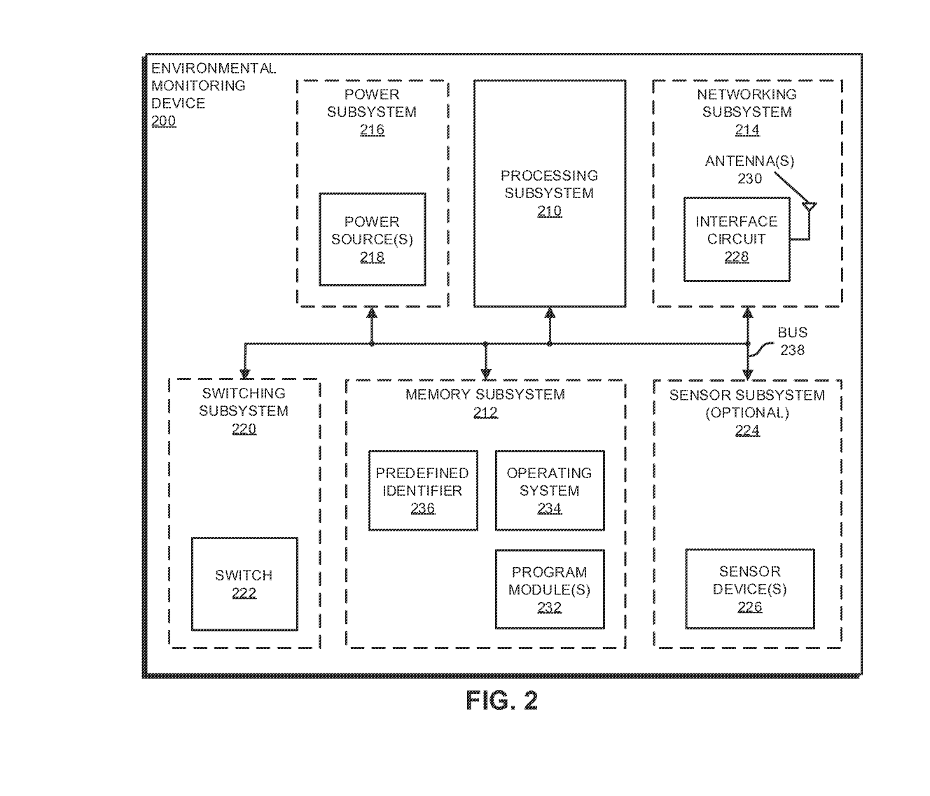

We now describe embodiments of an electronic device in FIG. 1. FIG. 2 presents a block diagram illustrating electronic device 200, such as one of electronic devices 110 and 112 (FIG. 1). This electronic device includes processing subsystem 210 (and, more generally, an integrated circuit or a control mechanism), memory subsystem 212, a networking subsystem 214, power subsystem 216, switching subsystem 220 and optional sensor subsystem 224 (i.e., a data-collection subsystem and, more generally, a sensor mechanism). Processing subsystem 210 includes one or more devices configured to perform computational operations and to execute techniques to process sensor data. For example, processing subsystem 210 can include one or more microprocessors, application-specific integrated circuits (ASICs), microcontrollers, programmable-logic devices, and/or one or more digital signal processors (DSPs).

Memory subsystem 212 includes one or more devices for storing data and/or instructions for processing subsystem 210, networking subsystem 214 and/or optional sensor subsystem 224. For example, memory subsystem 212 can include dynamic random access memory (DRAM), static random access memory (SRAM), and/or other types of memory. Memory subsystem 212 may store predefined identifier 236. In some embodiments, instructions for processing subsystem 210 in memory subsystem 212 include: one or more program modules 232 or sets of instructions, which may be executed in an operating environment (such as operating system 234) by processing subsystem 210. Note that the one or more computer programs may constitute a computer-program mechanism or a program module. Moreover, instructions in the various modules in memory subsystem 212 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 210.

In addition, memory subsystem 212 can include mechanisms for controlling access to the memory. In some embodiments, memory subsystem 212 includes a memory hierarchy that comprises one or more caches coupled to a memory in electronic device 200. In some of these embodiments, one or more of the caches is located in processing subsystem 210.

In some embodiments, memory subsystem 212 is coupled to one or more high-capacity mass-storage devices (not shown). For example, memory subsystem 212 can be coupled to a magnetic or optical drive, a solid-state drive, or another type of mass-storage device. In these embodiments, memory subsystem 212 can be used by electronic device 200 as fast-access storage for often-used data, while the mass-storage device is used to store less frequently used data.

Networking subsystem 214 includes one or more devices configured to couple to and communicate on a wired, optical and/or wireless network (i.e., to perform network operations and, more generally, communication), including an interface circuit 228 (such as a ZigBee® communication circuit) and one or more antennas 230. For example, networking subsystem 214 may include: a ZigBee® networking subsystem, a Bluetooth™ networking system (which can include Bluetooth™ Low Energy, BLE or Bluetooth™ LE), a cellular networking system (e.g., a 3G/4G network such as UMTS, LTE, etc.), a USB networking system, a networking system based on the standards described in IEEE 802.11 (e.g., a Wi-Fi® networking system), an Ethernet networking system, an infra-red communication system, a power-line communication system and/or another communication system (such as a near-field-communication system or an ad-hoc-network networking system).

Moreover, networking subsystem 214 includes processors, controllers, radios/antennas, sockets/plugs, and/or other devices used for coupling to, communicating on, and handling data and events for each supported networking or communication system. Note that mechanisms used for coupling to, communicating on, and handling data and events on the network for each network system are sometimes collectively referred to as a ‘network interface’ for the network system. Moreover, in some embodiments a ‘network’ between the electronic devices does not yet exist. Therefore, electronic device 200 may use the mechanisms in networking subsystem 214 for performing simple wireless communication between electronic device 200 and other electronic devices, e.g., transmitting advertising frames, petitions, beacons and/or information associated with near-field communication.

Moreover, electronic device 200 may include power subsystem 216 with one or more power sources 218. Each of these power sources may include: a battery (such as a rechargeable or a non-rechargeable battery), a DC power supply, a transformer, and/or a switched-mode power supply. Moreover, the one or more power sources 218 may operate in a voltage-limited mode or a current-limited mode. Furthermore, these power sources may be mechanically and electrically coupled by a male or female adaptor to: a wall or electrical-outlet socket or plug (such as a two or three-pronged electrical-outlet plug, which may be collapsible or retractable), a light socket (or light-bulb socket), electrical wiring (such as a multi-wire electrical terminal), a generator, a USB port or connector, a DC-power plug or socket, a cellular-telephone charger cable, a photodiode, a photovoltaic cell, etc. This mechanical and electrical coupling may be rigid or may be remateable. Note that the one or more power sources 218 may be mechanically and electrically coupled to an external power source or another electronic device by one of the electrical-connection nodes in switch 222 in switching subsystem 220.

In some embodiments, power subsystem 216 includes or functions as a pass-through power supply for one or more electrical connectors to an external electronic device (such as an appliance or a regulator device) that can be plugged into the one or more electrical connectors. Power to the one or more electrical connectors (and, thus, the external electronic device) may be controlled locally by processing subsystem 210, switching subsystem 220 (such as by switch 222), and/or remotely via networking subsystem 214.

Furthermore, optional sensor subsystem 224 may include one or more sensor devices 226 (or a sensor array), which may include one or more processors and memory. For example, the one or more sensor devices 226 may include: a thermal sensor (such as a thermometer), a humidity sensor, a barometer, a camera or video recorder (such as a CCD or CMOS imaging sensor), one or more microphones (which may be able to record acoustic information, including acoustic information in an audio band of frequencies, in mono or stereo), a load-monitoring sensor or an electrical-characteristic detector (and, more generally, a sensor that monitors one or more electrical characteristics), an infrared sensor (which may be active or passive), a microscope, a particle detector (such as a detector of dander, pollen, dust, exhaust, etc.), an air-quality sensor, a particle sensor, an optical particle sensor, an ionization particle sensor, a smoke detector (such as an optical smoke detector or an ionizing smoke detector), a fire-detection sensor, a radon detector, a carbon-monoxide detector, a chemical sensor or detector, a volatile-organic-compound sensor, a combustible gas sensor, a chemical-analysis device, a mass spectrometer, a microanalysis device, a nano-plasmonic sensor, a genetic sensor (such as a micro-array), an accelerometer, a position or a location sensor (such as a location sensor based on the Global Positioning System or GPS), a gyroscope, a motion sensor (such as a light-beam sensor), a contact sensor, a strain sensor (such as a strain gauge), a proximity sensor, a microwave/radar sensor (which may be active or passive), an ultrasound sensor, a vibration sensor, a fluid flow sensor, a photo-detector, a Geiger counter, a radio-frequency radiation detector, and/or another device that measures a physical effect or that characterizes an environmental factor or physical phenomenon (either directly or indirectly). Note that the one or more sensor devices 226 may include redundancy (such as multiple instances of a type of sensor device) to address sensor failure or erroneous readings, to provide improved accuracy and/or to provide improved precision.

During operation of electronic device 200, processing subsystem 210 may execute one or more program modules 232, such as an environmental-monitoring application that uses one or more sensor devices 226 to monitor one or more environmental conditions in an external environment that includes electronic device 200. The resulting sensor data may be used by the environmental-monitoring application to modify operation of electronic device and/or the external electronic device, and/or to provide information about the external environment to another (separate) electronic device (e.g., via networking subsystem 214).

Moreover, processing subsystem 210 may execute an identification application. This identification application may generate a programmed electrical characteristic based on predefined identifier 236. For example, processing subsystem 210 and/or power subsystem 216 may have a time-varying power consumption when the identification application is executed.

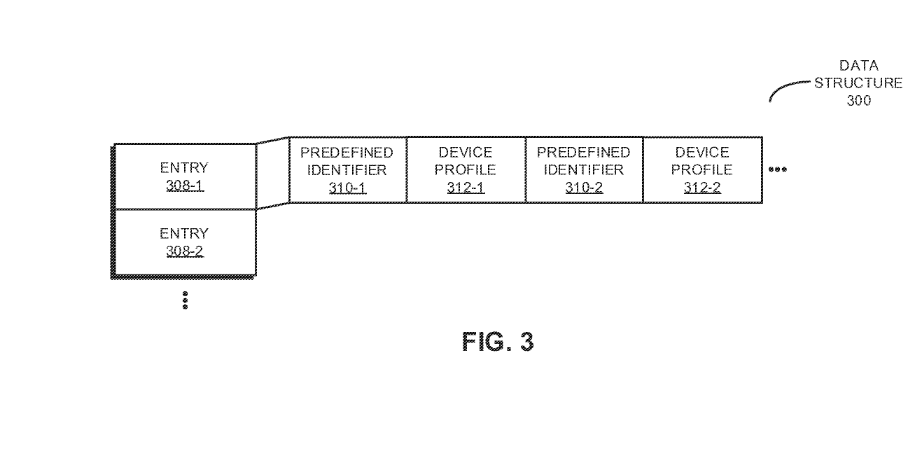

Furthermore, the identification application may use the one or more sensor devices 226 (such as an electrical-characteristic detector) to measure a modulated waveform associated with the other programmed electrical characteristic of another electronic device (such as the external electronic device). This modulated waveform may be analyzed using the one or more sensor devices 226 and/or the identification application to determine a predefined identifier of the other electronic device. Then, this determined predefined identifier may be associated with a device profile. In particular, networking subsystem 214 may communicate the determined predefined identifier to a separate electronic device (such as a remote computer system), which may respond by providing the device profile. Alternatively or additionally, identification application may obtain the device profile by accessing or looking it up in a data structure stored in memory subsystem 212. This is illustrated in FIG. 3, which presents a data structure 300 that includes one or more entries 308 with one or more: predefined identifiers 310, and associated device profiles 312. Note that device profiles 312 may include information about user of the external electronic device, which may include one or more predefined preferences of the user.

Referring back to FIG. 2, after the device profile has been obtained (i.e., accessed and/or received), identification application may share this information and/or the determined predefined identifier with one or more other electronic devices via networking subsystem 218. Note that providing the predefined identifier may allow the one or more other electronic devices to obtain the device profile if it is not provided directly by electronic device 200.

Within electronic device 200, processing subsystem 210, memory subsystem 212, networking subsystem 214, power subsystem 216, switching subsystem 220 and/or optional sensor subsystem 224 may be coupled using one or more interconnects, such as bus 238. These interconnects may include an electrical, optical, and/or electro-optical connection that the subsystems can use to communicate commands and data among one another. Note that different embodiments can include a different number or configuration of electrical, optical, and/or electro-optical connections among the subsystems.

Electronic device 200 can be (or can be included in) a wide variety of electronic devices. For example, electronic device 200 can be (or can be included in): a sensor (such as a smart sensor), a tablet computer, a smartphone, a cellular telephone, an appliance, a regulator device, a consumer-electronic device (such as a baby monitor), a portable computing device, test equipment, a digital signal processor, a controller, a personal digital assistant, a laser printer (or other office equipment such as a photocopier), a personal organizer, a toy, a set-top box, a computing device (such as a laptop computer, a desktop computer, a server, and/or a subnotebook/netbook), a light (such as a nightlight), an alarm, a smoke detector, a carbon-monoxide detector, a monitoring device, and/or another electronic device (such as a switch or a router).

Although specific components are used to describe electronic device 200, in alternative embodiments, different components and/or subsystems may be present in electronic device 200. For example, electronic device 200 may include one or more additional processing subsystems, memory subsystems, networking subsystems, power subsystems, switching subsystems, and/or sensor subsystems. Additionally, one or more of the subsystems may not be present in electronic device 200. Moreover, in some embodiments, electronic device 200 may include one or more additional subsystems that are not shown in FIG. 2, such as a user-interface subsystem, a display subsystem, and/or a feedback subsystem (which may include speakers and/or an optical source).

Although separate subsystems are shown in FIG. 2, in some embodiments, some or all of a given subsystem or component can be integrated into one or more of the other subsystems or components in electronic device 200.

For example, in some embodiments the one or more program modules 232 are included in operating system 234. In some embodiments, a component in a given subsystem is included in a different subsystem.

Moreover, the circuits and components in electronic device 200 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit may implement some or all of the functionality of networking subsystem 214 (such as a radio) and, more generally, some or all of the functionality of electronic device 200. Moreover, the integrated circuit may include hardware and/or software mechanisms that are used for transmitting wireless signals from electronic device 200 to, and receiving signals at electronic device 200 from other electronic devices. Aside from the mechanisms herein described, radios are generally known in the art and hence are not described in detail. In general, networking subsystem 214 and/or the integrated circuit can include any number of radios. Note that the radios in multiple-radio embodiments function in a similar way to the radios described in single-radio embodiments.

In some embodiments, networking subsystem 214 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals, e.g., determining if the received signal comprises an advertising frame, a petition, a beacon, etc.)

While wired communication was used as an illustrative example, the described embodiments of electronic device 200 may use a variety of network or communication interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both.

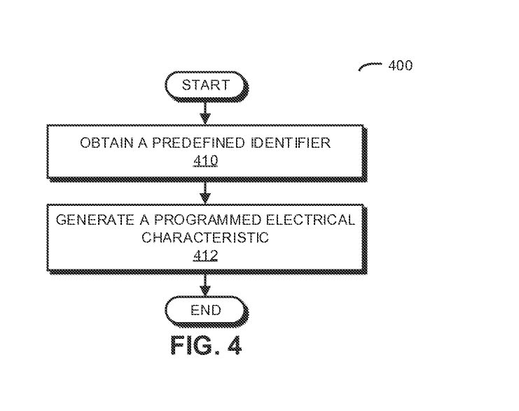

We now further describe the communication technique and operation of the electronic device. FIG. 4 presents a flow diagram illustrating a method 400 for generating a programmed electrical characteristic in an electronic device, such as electronic device 110 (FIG. 1). During operation, the electronic device obtains the predefined identifier (operation 410) that specifies the information about the electronic device. For example, the predefined identifier may be stored in a storage component in the electronic device. Note that the predefined identifier may include: a unique numerical identifier of the electronic device (such as a media access control or MAC address of the electronic device), the user's cellular-telephone number and/or information specifying the user's account (such as an account number) with a provider of the electronic device, etc.

Then, during operation of the electronic device, a control mechanism (such as an integrated circuit, a processor or control logic) in the electronic device generates the programmed electrical characteristic (operation 412) associated with or based on the predefined identifier, where the programmed electrical characteristic includes varying the power consumption of the electronic device.

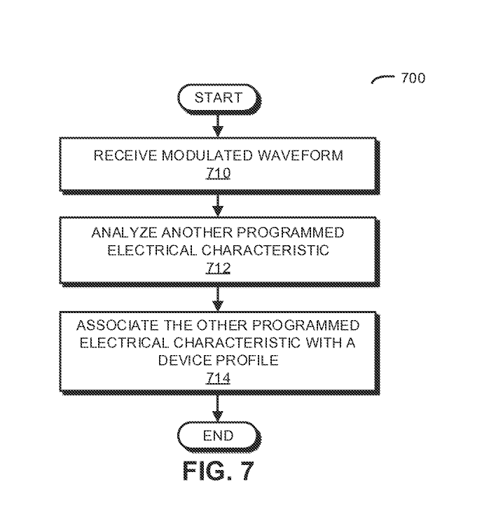

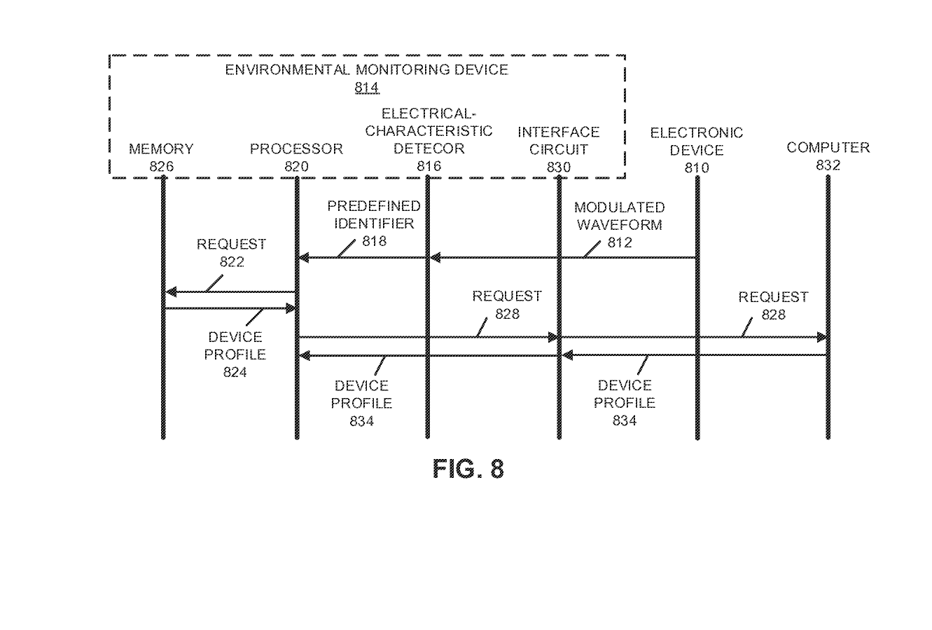

In these ways, the identity of the electronic device (and/or the user of the electronic device) may be indirectly provided to one or more other electronic devices. In particular, as described further below with reference to FIGS. 7 and 8, the one or more other electronic devices may detect a modulated waveform associated with the programmed electrical characteristic, which specifies the predefined identifier of the electronic device.

In an exemplary embodiment, the programmed electrical characteristic includes a time-varying power consumption of the electronic device, such as a power-up transient signal of the electronic device. This is shown in FIG. 5, which presents a drawing illustrating a programmed electrical characteristic of the electronic device. In particular, programmed electrical characteristic may include a power-up transient signal 514 with a power consumption 510 that varies with time 512 (which is sometimes referred to as a ‘time-varying power consumption’) and that is associated with the predefined identifier of the electronic device. This time-varying power consumption may include a sequence of two or more discrete (or approximately discrete) power-consumption levels. Moreover, these power-consumption levels may be associated with operation of an integrated circuit in the electronic device based on a predefined identifier, such as execution of a program module by a processor in the electronic device (e.g., initialization of firmware by the processor, selectively activating a circuit or block in the processor to vary the power consumption as a function of time, etc.). Furthermore, the power-consumption levels may correspond to (or represent): a pulse-code modulation sequence, a quadrature-modulation sequence, and/or a DC-balanced sequence. Thus, the power-consumption levels may represent digital values in the predefined identifier. In some embodiments, the power-consumption levels include information encoded with: an error-detection code, a parity-bit technique, a checksum, a hash function, a cyclic-redundancy check, a hamming code, and/or an error-correction code. While FIG. 5 illustrates a particular type of coding, in other embodiments other codes and/or modulation techniques may be used, including: amplitude modulation, frequency modulation and/or spread-spectrum modulation. In addition, while FIG. 5 illustrates a particular example of the time-varying power consumption, more generally the time-varying power consumption includes a modulated waveform.

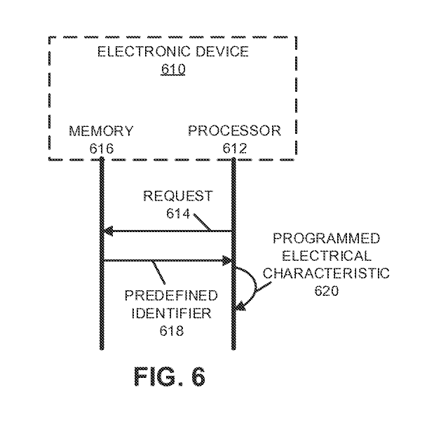

FIG. 6 presents a drawing illustrating communication within the electronic device during method 400 (FIG. 4). During operation of electronic device 610 (such as during an identification mode of operation), processor 612 may request 614 and subsequently receive predefined identifier 618 from memory 616.

Then, processor 612 may generate the programmed electrical characteristic 620 based on predefined identifier 618. For example, processor 612 may generate the programmed electrical characteristic 620 by executing a program module (such as an identification application).

FIG. 7 presents a flow diagram illustrating a method 700 for associating another programmed electrical characteristic with a device profile for another electronic device, such as electronic device 112 (FIG. 1), which may be performed by electronic device 110 (FIG. 1). During operation, the electronic device receives the modulated waveform (operation 710) that corresponds to (or represents or is a function of) the other programmed electrical characteristic of the other electronic device. Then, the electrical-characteristic detector in the electronic device analyzes the other programmed electrical characteristic (operation 712), and associates the other programmed electrical characteristic with the device profile (operation 714). For example, the predefined identifier of the other electronic device may be determined during the analysis. This determined predefined identifier may be used to obtain the device profile, such as from another electronic device (e.g., in memory in a separate and/or remote computer system) and/or by looking up the device profile stored in local memory based on or using the determined predefined identifier. Note that the device profile may include information about the other electronic device (such as specifications and/or components in the other electronic device, predictive models of component lifetime or failure rates, etc.) and/or a user of the other electronic device (such as predefined user preferences).

In some embodiments, the modulated waveform conveys or communicates information about an operating condition or state of the other electronic device. For example, the operating condition may include an alarm condition or state of a smoke detector or a carbon-monoxide detector, which may be communicated even if the audio circuit or audio transducer on the smoke alarm or the carbon-monoxide detector was defective. After receiving the operating condition, the electronic device may communicate this information to one or more additional electronic devices (such as a cellular telephone of a user of the other electronic device).

In an exemplary embodiment, the device information allows the electronic device to provide improved functionality and services. For example, the electronic device may recognize the type, brand, an operating condition of the other electronic device, and/or model of the other electronic device. This may assist the electronic device in monitoring aging of the other electronic device. When impending failure is predicted (or a failure is detected), the electronic device may provide an alert to a user of the other electronic device. The electronic device may also perform remedial action, such as: ordering a replacement component or electronic device, schedule maintenance (e.g., with a maintenance provider), etc.

In some embodiments, the electronic device associates the user of the other electronic device (and, more generally, an individual) with the determined predefined identifier based a predefined list of electronic devices of the user. For example, user-account information may include the predefined list of the user's electronic devices. Then, a processor (or an integrated circuit, a control mechanism or control logic) in the electronic device may use the determined predefined identifier and the predefined list to lookup the user.

Moreover, the processor may obtain or access a predefined preference of the user. As described previously, operation of the electronic device (such as selectively electrically coupling or decoupling the other electronic device from a power source) may be based on the predefined preference.

For example, the predefined preference may specify a threshold value for the environmental condition (such as a maximum temperature of 80 F or a minimum temperature of 65 F, a maximum humidity of 80% or a minimum humidity of 30%, a maximum or a minimum concentration of a chemical or an allergen in the external environment, etc.), and a switch in the electronic device may selectively electrically couple or decouple the other electronic device from the power source based on the threshold value. In this way, a regulator device (such as a fan, an air conditioner, a heater, an air filter, a humidifier, etc.) may be selectively activated. Alternatively or additionally, the predefined preference may be related to a medical condition of the user or an illumination preference (such as desired lighting conditions at a particular time of day). Note that, while preceding discussion illustrated selective electrical coupling or decoupling based on a static or fixed preference, more generally, the preference may evolve or change as a function of time or the environmental condition, which may allow the electronic device to dynamically respond to or control the environmental condition.

While the preceding embodiments illustrated the identification of the other electronic device (as well as associated information, such as a type, a model, an operating condition, or a brand) by measuring the other programmed electrical characteristic, in other embodiments the identity of the other electronic device (or the associated information) is, at least in part, determined based on additional factors. For example, an electrical characteristic measured by a load-monitoring sensor may be associated with the device profile, which may include metadata that facilitates the identification. This association may also be based on a location of the electronic device (such as in the bathroom), which may facilitate the identification. In some embodiments, the user of the electronic device is queried to facilitate the identification. For example, the user may be asked (e.g., via communication with the user's cellular telephone) to identify the other electronic device.

Furthermore, changes to the environmental condition (such as a change in the temperature or the humidity) after a change in a state of the electronic device may facilitate the identification. For example, the change in state may include using switching to selectively electrical couple or decouple the other electronic device from a power source. Then, the presence (or absence) of sound after the change in state may facilitate identification of the other electronic device as stereo equipment. Similarly, a change in the temperature after the change in state may facilitate identification of the other electronic device as a thermostat. Furthermore, a change in the humidity after the change in state may facilitate identification of the other electronic device as a humidifier.

FIG. 8 presents a drawing illustrating communication within the electronic device during method 700 (FIG. 7). During operation of electronic device 810, a programmed electrical characteristic is generated (as illustrated in FIG. 6) and a resulting modulated waveform 812 is provided to electronic device 814. Electrical-characteristic detector 816 receives modulated waveform 812 and determines predefined identifier 818. This predefine identifier is provided to processor 820.

Then, processor 820 optionally requests 822 and obtains device profile 824 from memory 826. Alternatively or additionally, processor 820 optionally provides request 828 to interface circuit 830. In response, interface circuit 830 optionally provides request 828 to computer 832, which responds by optionally providing device profile 834 (which may be the same as or different from device profile 826). Next, interface circuit 830 optionally provides device profile 834 to processor 820.

In some embodiments of one or more of the preceding methods, there may be additional or fewer operations. Furthermore, the order of the operations may be changed, and/or two or more operations may be combined into a single operation. In addition, in some of the preceding embodiments there are fewer components, more components, a position of a component is changed and/or two or more components are combined.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. An electronic device, comprising:
a power supply electrically coupled to external electrical-connection nodes, wherein, during operation, the power supply provides a power signal; and
a processor, electrically coupled to the power supply, which, during operation, executes a program module to generate a programmed electrical characteristic based on a unique identifier of the electronic device, wherein the programmed electrical characteristic includes a time-varying power consumption of the electronic device that is expressed on the external electrical-connection nodes; and
wherein the program module selectively turns blocks in the processor on and off in a temporal sequence corresponding to the unique identifier to generate the time-varying power consumption of the electronic device.

2. The electronic device of claim 1, wherein the programmed electrical characteristic is provided one of: a first time the electrical device is powered on at a particular location; and a first time the electrical device communicates with another electronic device.

3. The electronic device of claim 2, wherein the programmed electrical characteristic is provided in response to a request received from the other electronic device.

4. The electronic device of claim 2, wherein the programmed electrical characteristic is provided until an acknowledgment is received from the other electronic device.

5. The electronic device of claim 1, wherein the programmed electrical characteristic only occurs during a power-up transient signal of the electronic device; and
wherein the programmed electrical characteristic is superimposed on the power-up transient signal.

6. The electronic device of claim 1, wherein, during operation, the unique identifier is received from another electronic device so that the programmable electrical characteristic is dynamically and remotely programmed.

7. The electronic device of claim 1, wherein, during operation, information specifying one of a set of program modules is received from another electronic device so that the programmable electrical characteristic is dynamically and remotely programmed.

8. The electronic device of claim 1, wherein the electronic device further comprises a storage component; and
wherein the storage component stores information specifying the unique identifier.

9. The electronic device of claim 1, wherein the programmed electrical characteristic includes one of: a time-varying current, a time-varying voltage, a time-varying phase relative to at least a reference signal, a time-varying quality factor, a time-varying harmonic of a fundamental frequency, a time-varying resonance frequency, a time-varying time constant, and time-varying noise.

10. The electronic device of claim 1, wherein the time-varying power consumption includes a sequence of approximately discrete values.

11. The electronic device of claim 1, wherein the programmed electrical characteristic corresponds to one of: a pulse-code modulation sequence, a quadrature-modulation sequence, and a DC-balanced sequence.

12. The electronic device of claim 1, wherein the programmed electrical characteristic includes information encoded with one of: an error-detection code, a parity-bit technique, a checksum, a hash function, a cyclic-redundancy check, a hamming code, and an error-correction code.

13. The electronic device of claim 1, wherein the program module includes firmware that is executed by the processor during initialization.

14. The electronic device of claim 1, wherein the external electrical-connection nodes are configured to electrically couple to a second electronic device;
wherein the electronic device further comprises an electrical-characteristic detector electrically coupled to the external electrical-connection nodes; and
wherein the electrical-characteristic detector is configured to detect another programmed electrical characteristic associated with the second electronic device from a time-varying power consumption of the second electronic device.

15. The electronic device of claim 14, wherein, during operation, the electrical-characteristic detector analyzes the other programmed electrical characteristic, and associates the other programmed electrical characteristic with a device profile.

16. The electronic device of claim 15, further comprising an interface circuit that, during operation, communicates information with a third electronic device, wherein, during operation, the device profile associated with the other programmed electrical characteristic is communicated, via the interface circuit, to the third electronic device.

17. The electronic device of claim 15, wherein, during operation of the electronic device, the processor executes an interrupt service routine program that performs the analysis and the association when the processor receives an interrupt from the electrical-characteristic detector.

18. The electronic device of claim 14, wherein the other programmed electrical characteristic includes a modulated waveform; and
wherein the electronic device further comprises a signal filter, electrically coupled to the external electrical-connection nodes, which, during operation, removes noise from the modulated waveform prior to the electrical-characteristic detector.

19. A computer-program product for use in conjunction with an electronic device, the computer-program product comprising a non-transitory computer-readable storage medium and a computer-program mechanism embedded therein to generate a programmed electrical characteristic, the computer-program mechanism including:
instructions for obtaining a unique identifier of the electronic device; and
instructions for generating a programmed electrical characteristic based on the unique identifier by executing a program module using a processor in the electronic device, wherein the programmed electrical characteristic includes a time-varying power consumption of the electronic device that is expressed on external electrical-connection nodes that are electrically coupled to a power supply in the electronic device; and
wherein, when generating the programmed electrical characteristic, the program module selectively turns blocks in the processor on and off in a temporal sequence corresponding to the unique identifier to generate the time-varying power consumption of the electronic device.

20. A processor-implemented method for generating a programmed electrical characteristic, wherein the method comprises:
obtaining a unique identifier of an electronic device; and
generating the programmed electrical characteristic based on the unique identifier by executing a program module using the processor in the electronic device, wherein the programmed electrical characteristic includes a time-varying power consumption of the electronic device that is expressed on external electrical-connection nodes that are electrically coupled to a power supply in the electronic device; and
wherein, when generating the programmed electrical characteristic, the program module selectively turns blocks in the processor on and off in a temporal sequence corresponding to the unique identifier to generate the time-varying power consumption of the electronic device.
